(19) United States
(12) Patent Application Publication
(10) Pub. No.: US 2006/0225653 A1
(43) Pub. Date: Oct. 12, 2006

(54) Apparatus and method for generating uniform plasmas

(76) Inventors: Shu Yan Xu, Singapore (SG); Kostyanfyn Ostrikov, Singapore (SG); Erekle Tsakadze, Singapore (SG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/566,122

(22) PCT Filed: Jul. 13, 2004
(86) PCT No.: PCT/SG04/00210

§ 371 Date: Jan. 25, 2006

(30) Foreign Application Priority Data
Jul. 25, 2003 (SG) 200303896-5

(51) Int. Cl. G09G 3/10

(52) U.S. Cl. 118/723 E; 345/37

(57) ABSTRACT

Disclosed is an apparatus for generating high-density, highly uniform plasmas for plasma processing and synthesis of advanced materials. The apparatus includes a reactor chamber and a chamber top, the chamber top housing two mutually perpendicular sets of equally spaced current carrying conductors (25, 26) coupled in series to a low frequency, radiofrequency generator. Two initially mutually perpendicular unidirectional oscillating current sheets and a time-varying electric field that is azimuthally shifted on 45° with respect to the directions of both current sheets are generated. The plasma produced features high density, low electron temperature, and improved as compared with conventional sources of inductively coupled plasmas with external flat spiral coils, uniformity of plasma density, electron temperature, and plasma potential over large areas and volumes. The proposed method of highly uniform plasma production does not rely on expensive additional magnetic dipolar/multipolar confinement. The apparatus can be up-scaled towards larger dimensions without compromising the production and uniformity of the plasma.

### FIELD OF THE INVENTION

This invention is related to plasma generation. Specifically, it refers to an apparatus and method for generating high-density, highly uniform plasmas for a broad range of plasma processing applications in semiconductor, optical, automotive, biopharmaceutical and other industries.

### BACKGROUND OF THE INVENTION

Plasma sources employing a variety of low-pressure (typically 1 mTorr-few Torr) gas discharges, including direct current (DC), radio-frequency (RF) and microwave discharges. These plasmas are extensively used by many industries for processing various dielectric, semiconductor, and conducting surfaces and bulk materials. Nowadays, the applications of the plasma discharges expand into the areas of synthesis of novel and advanced nanostructured and biocompatible materials with advanced functionalities.

Inductively coupled plasmas (ICPs) is a subclass of RF gas discharges, which has recently attracted a great deal of interest as efficient sources of high-density (>10¹¹—10¹² cm⁻³) low temperature plasmas in large volumes and over large surface areas. ICP discharges provide the independent control of the ion flux and ion-bombarding energy, high efficiency in terms of ionization and power utilization, and have several other attractive features, which make them promising sources of low-temperature plasmas for the semiconductor industry, synthesis of novel and advanced materials and fabrication of unique nanostructures.

In ICP reactors, plasma is produced by RF electromagnetic field generated by inductive coils of various configurations placed outside or inside the processing chamber. RF power is coupled to the plasma inductively, via excitation of RF currents in the chamber volume. The power that can be gainfully used for the plasma production critically depends on the configuration of the electromagnetic fields and RF currents excited in the chamber. Most of the existing ICP sources use 13.56 MHz RF generators to drive RF currents in the inductive coil.

However, some of the applications of the existing ICP devices suffer from non-uniformities of the main plasma parameters caused by non-uniform RF power deposition. In particular, in the 13.56 ICP devices employing flat spiral (“pancake”) inductive coils, most commonly adopted in the semiconductor manufacturing, the above non-uniformities persist in the areas near the chamber axis. Secondly, generation and maintaining uniformity of inductively coupled plasmas over large volumes has proved to be a problem. This can result in a substantial drawback in application of ICP device for technological processes that require high level of uniformity over large volumes. It is understood that this is intrinsic to most of external-coil configurations featuring noticeable decays in ion density along axial direction. Data on axial profiles of optical emission intensity (which is proportional to the number densities of species) of ionic and neutral argon species ICPs confirm that the ion density noticeably diminishes at distances less than a half of the chamber length. Another shortcoming of the external-coil ICP configurations is a substantial RF power loss to the ambient that affects the power transfer efficiency.

Several attempts have been reported to solve the non-uniformity problem by modifying the RF power coupling, coil structures or plasma confinement. Relevant background arts on generating plasma and improving spatial uniformity of the main parameters of plasma are discussed briefly.

Keller, et. al. U.S. Pat. No. 5,767,628, discloses a plasma processing tool, which utilizes a ferromagnetic induction coil with plural magnetic dipoles for production of well-confined plasmas.

Chen, et al. WO Pat. No. 99/50885, discloses a parallel-antenna transformer-coupled plasma generation system, with a set of parallel coupling elements is positioned on a dielectric window of a plasma chamber and the radio frequency current flowing within the elements is oriented in a similar direction. The inductively coupled fields in the reactor are reinforcing, and the highly uniform plasma is generated.

Chen, et al. WO Pat. No. 00/00993, discloses a multiple coil antenna for inductively coupled plasma generation systems. Multiple coils are positioned on a dielectric window of a plasma chamber and are either planar or a combination of a planar coil and a vertically stacked helical coil. By adjusting the inductive coupling of each coil, radially and azimuthally uniform plasma can be achieved.

Kim, et al. WO Pat. No. 03/017738, discloses a large-area plasma antenna and plasma source for production of uniform plasmas. The antenna is composed of interconnected inner and outer coils and is able to regulate the strength of the induced electric field and produce the large area uniformity in the reactor.

Wu, et al. [Appl. Phys. Leti 72, 777-779(1998)], reported on production of high-density large-area inductively coupled plasmas by launching a 13.56 MHz traveling wave in a series connection of eight parallel rods embedded in the plasma inside thin quartz tubes.

Notwithstanding the above and other prior art references, there is still a need for a source of high-density, large-area and large-volume inductively coupled plasmas, with the improved, as compared with the existing plasma sources, uniformity of electron/ion number densities.

### OBJECTIVES OF THE INVENTION

It is an object of the invention to disclose a new method for producing plasma by introducing two mutually orthogonal unidirectional current sheets oscillating at a low frequency inside a vacuum chamber.

It is another object of the invention to disclose a new method and apparatus for production of highly uniform plasma in both radial and axial directions.

It is still another object of the invention to disclose a plasma reactor that can be up-scaled towards larger dimensions without compromising the uniformity of the plasma parameters.

It is yet a further object of the invention to achieve the desired plasma uniformity without any external DC magnetic field configurations or electrostatic shielding.

### SUMMARY OF THE INVENTION

The present invention seeks to provide an apparatus and method for generating uniform plasmas.

Accordingly, in one aspect, the present invention provides, a method for generating a highly uniform plasma, the method comprising the steps: introducing a process gas into a plasma reactor; introducing a first unidirectional oscillating RF current sheet in a first direction and a second unidirectional oscillating RF current sheet in a second direction inside the plasma reactor; wherein the first unidirectional oscillating RF current sheet is substantially perpendicular to the second unidirectional oscillating current sheet.

In another aspect, the present invention provides, a method for generating a highly uniform plasma, the method comprising the steps: introducing a process gas into a plasma reactor, introducing a unidirectional oscillating RF current into a first plurality of current carrying conductors in a first direction and a second plurality of current carrying conductors in a second direction; and generating a time varying RF electrical field azimuthally shifted on 45° with respect to the first and second direction of the unidirectional oscillating RF currents; wherein the unidirectional oscillating RF current in the first and second plurality of current carrying conductors exhibit substantially no phase differences.

In yet another aspect, the present invention provides, a method for generating a highly uniform plasma, the method comprising the steps: introducing a process gas into a plasma reactor, introducing a first unidirectional oscillating RF current into a first plurality of current carrying conductors in a first direction; introducing a second unidirectional oscillating RF current into a second plurality of current carrying conductors in a second direction; and generating a time varying RF electrical field azimuthally shifted on 45° with respect to the first and second direction of the first and second unidirectional oscillating RF currents; wherein the first and second unidirectional oscillating RF currents exhibit substantially no phase differences.

In a further aspect, the present invention provides, a method for generating a highly uniform plasma, the method comprising the steps: introducing a process gas into a plasma reactor; introducing a unidirectional oscillating RF current into a first plurality of current carrying conductors in a first direction; introducing the unidirectional oscillating RF current into a second plurality of current carrying conductors in a second direction; and generating a time varying RF electrical field azimuthally shifted on 45° with respect to the first, and second direction of the unidirectional oscillating RF currents; wherein the unidirectional oscillating RF current in the first and second plurality of current carrying conductors exhibit substantially no phase differences.

In yet a further aspect, the present invention provides, an antenna arrangement for an inductively coupled plasma reactor comprising: a first plurality of substantially parallel current carrying conductors oriented in a first direction; a second plurality of substantially parallel current carrying conductors oriented in a second direction; wherein the first and second current carrying conductors for carrying unidirectional oscillating RF currents in a first and second direction respectively; and the first direction being substantially perpendicular to the second direction; further wherein the first plurality of substantially parallel current carrying conductors is disposed planarly above the second plurality of substantially parallel current carrying conductors.

In a final aspect, a plasma reactor comprising: a plasma reactor chamber adapted for plasma processing and for introducing of a process gas; and an antenna arrangement comprising a first plurality of substantially parallel current carrying conductors in a first direction; and a second plurality of substantially parallel current carrying conductors in a second direction; wherein the first and second plurality of current carrying conductors for carrying unidirectional oscillating RF currents in a first and second direction respectively; and the first direction being substantially perpendicular to the second direction; further wherein the first plurality of substantially parallel current carrying conductors is disposed planarly above the second plurality of substantially parallel current carrying conductors.

### BRIEF DESCRIPTION OF THE DRAWINGS

A preferred embodiment of the present invention will now be more fully described, with reference to the drawings of which:

FIG. 1 illustrates a cross sectional side view of a plasma reactor in accordance with the present invention;

FIG. 2 illustrates a top view of the antenna arrangement of FIG. 1 in accordance with the present invention;

FIG. 3 illustrates the wiring connection of the antenna arrangement in FIG. 2;

FIG. 4A illustrates a simplified equivalent circuit for the electrical connections of FIG. 3;

FIG. 4B illustrates an alternative equivalent circuit for the electrical connections of FIG. 4A;

FIG. 4C illustrates a vector diagram of voltage drops of FIG. 4A and FIG. 4B;

FIG. 5 illustrates uniformity of the generated plasma in a radial direction in accordance with the present invention;

FIG. 6 illustrates uniformity of the generated plasma in an axial direction in accordance with the present invention;

FIG. 7 illustrates performance of the generated plasma in the electrostatic (E) and electromagnetic (H) modes; and

FIG. 8 illustrates the main parameters of the generated plasma in varying operating pressures.

### DETAILED DESCRIPTION OF THE DRAWINGS

An apparatus and method for generating uniform plasma in a preferred embodiment is described. In the following description, details are provided to describe a preferred and an alternate embodiment. It shall be apparent to one skilled in the art, however that the invention may be practiced without such details. Some of the details may not be described at length so as not to obscure the invention.

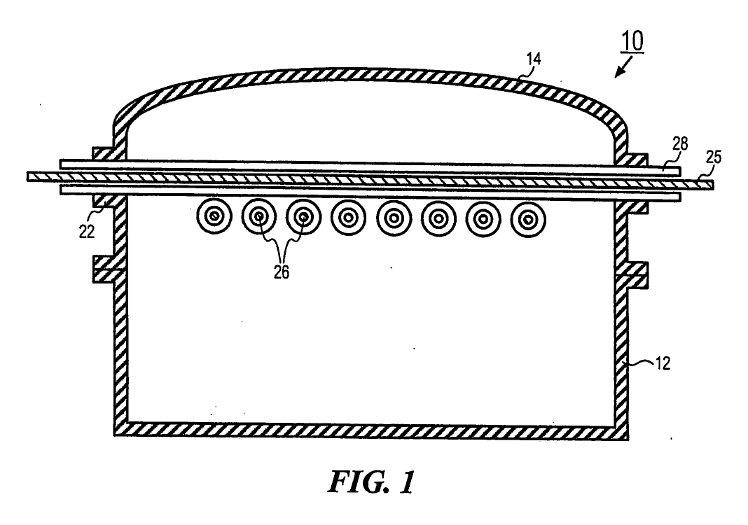

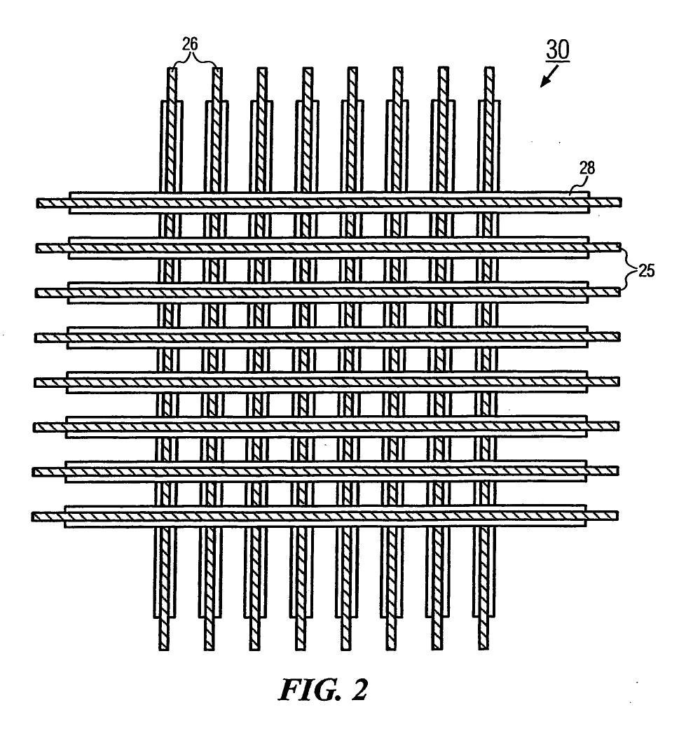

Referring to FIG. 1 and FIG. 2, a plasma reactor 10 in accordance with the present invention comprises a reactor chamber 12, a chamber top 14 and an antenna arrangement 30 comprising a plurality of current carrying conductors 25, 26 arranged in a predetermined manner in accordance with the present invention.

The plasma reactor 10 may further comprise a variety of portholes, inlets and outlets (not shown in the drawings) for introducing process gases and for mounting diagnostic tools to probe into the reactor chamber 12. The walls of the plasma reactor 10 may be double-walled and may also comprise cooling means for cooling the plasma reactor 10.

The chamber top 14 houses the antenna arrangement 30, which comprises a first 25 plurality of current carrying conductors and a second 26 plurality of current carrying conductors. The first 25 plurality of current carrying conductors are substantially parallel to each other and the second 26 plurality of current carrying conductors are similarly substantially parallel to each other. The first 25 plurality of current carrying conductors are housed in the chamber top 14 such that they are mounted planarly above the second 26 plurality of current carrying conductors.

Each of the plurality of current carrying conductors 25, 26 are further housed in individual dielectric sleeves 28 to isolate them from the process gas inside the plasma reactor 10. The dielectric sleeves 28 can be made from fused silica or alumina. The dielectric sleeves 28 are mounted inside the chamber top 14 via ports 22. The ports 22 allow the dielectric sleeves 28 to be mounted inside the chamber top 14, which is also inside the plasma reactor 10. The ports 22 are also adapted to maintain vacuum integrity of the plasma reactor 10 by being sealed with the dielectric sleeves 28. The vacuum tight seal between the dielectric sleeves 28 and the ports 22 may be formed by using epoxy seals or other known sealants and sealing methods.

Furthermore, the first 25 plurality of current carrying conductors are adapted to carry a unidirectional oscillating RF current in a first direction and the second 26 plurality of current carrying conductors are similarly adapted to carry a unidirectional oscillating current in a second direction. The first and second direction being substantially perpendicular or orthogonal to each other.

Generating a plasma from the plasma reactor 10 would involve a method having the steps of firstly introducing a process gas into the reactor chamber 12 of the plasma reactor 10. Next, simultaneously introducing a first unidirectional oscillating RF current into the first 25 plurality of current carrying conductors in the first direction and introducing a second unidirectional oscillating RF current into the second 26 plurality of current carrying conductors. A time varying RF electrical field azimuthally shifted on 45 with respect to the first and second direction of the first 25 and second 26 unidirectional oscillating RF currents is thus generated.

In the preferred embodiment of the present invention the first and second unidirectional oscillating RF currents may be powered by a single RF generator. By implementing a predetermined connection pattern, the first 25 and second 26 plurality of current carrying conductors of the antenna arrangement 30 may be coupled in series alternately and to a single RF generator.

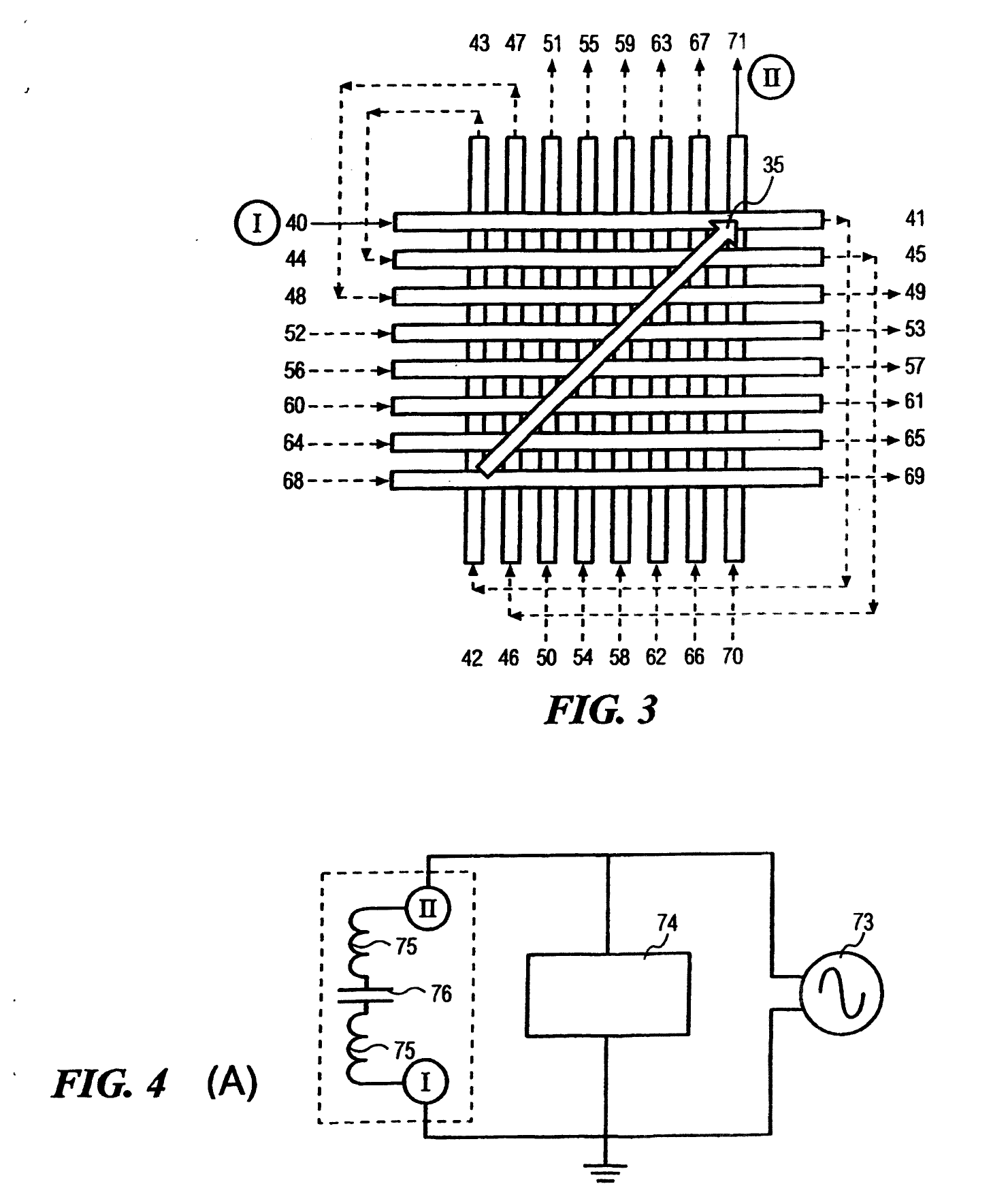

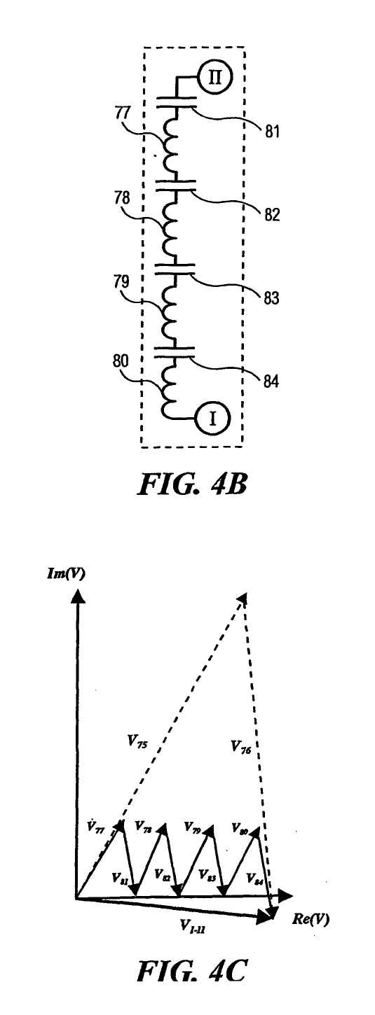

Referring to FIG. 3 and FIG. 4A, the electrical connections of the antenna arrangement 30 results in each of the first 25 plurality of current carrying conductors carrying the unidirectional oscillating RF current in the same first direction and in substantially similar phase. Each of the second 26 plurality of current carrying conductors similarly carry the unidirectional oscillating RF current in the second direction and in substantially similar phase. The first and second direction being substantially perpendicular or orthogonal to each other. Very little or no phase difference is experienced by the preferred plasma reactor 10 operation at lower, than conventional, radio frequencies in the range of 300 kHz to 1000 kHz. In this range, wavelengths of electromagnetic fields are typically much larger than the dimensions of the antenna arrangement of the present invention.

Referring to FIG. 3, the wiring arrangement of the electrical connections for the antenna arrangement 30 is shown. The example shown in FIG. 3, comprises eight current carrying conductors in each of the first and second direction. The unidirectional oscillating RF current enters a first end of one of the first 25 plurality of current carrying conductor at point 40, at a second end of the same current carrying conductor, point 41 is then coupled to a first end of one of the second 26 plurality of current carrying conductors at point 42. At a second end of the same current carrying conductor, point 43 is then coupled to a next uncoupled current carrying conductor of the first 25 plurality of current carrying conductors. The connection pattern follows the points 40 to 71 where each of the first plurality 25 of current carrying conductors are alternately coupled to each of the second 26 plurality of current carrying conductors.

The resulting direction of RF current generated by the first 25 and second 26 plurality of current carrying conductors is illustrated by the arrow 35. The resulting RF current can be considered a unidirectional RF current sheet oscillating within the reactor chamber 12. The connection pattern of FIG. 3 follows a principle of minimal combined length of external coupling wires. This connection pattern also advantageously minimizes the inductive reactance of the antenna arrangement 30. The current carrying conductors 25, 26 may be coupled via external coupling wires made of copper litz.

Generating a plasma would then involve a method having the steps of first introducing a process gas into the plasma reactor 10 and then simultaneously introducing a first unidirectional oscillating RF current sheet in the first direction and a second unidirectional oscillating RF current sheet in a second direction inside the plasma reactor 10. The time varying RF electrical field generated is then azimuthally shifted on 45° with respect to the first and second direction of the first and second unidirectional oscillating RF current sheets.

Referring to FIG. 4A, the antenna arrangement 30 is represented by two phases 75 and is further coupled to a RF generator 73 via an electrically grounded matching network 74. The two phases 75 of the antenna arrangement are coupled together via the impedance tuning capacitor 76.

The RF generator 73, an example of which is an “Advanced Energy model PDX 8000” running at about 460 kHz can be used to power the antenna arrangement 30. In the present example, the range of power supplied to the antenna arrangement 30 varies in the range of 100 to 2500 W into a 50Ω, non-reactive load. The matching network 74, an example of which is a standard L-type matching network, can be used to match the characteristic impedance of the RF generator 73 to the load impedance of the plasma reactor 10. This ensures maximum power deposition into the reactor chamber 12.

Referring to FIG. 4A, the voltage drop across the phases 75 of the antenna arrangement 30 and the impedance tuning capacitor 76 can be very large. To avoid such high voltage drops, the antenna arrangement 30 can be divided into four equal phase segments 77-80 as shown in FIG. 4B, wherein the inductance of each phase segment 77-80 is approximately L/4. In the present example, required capacitance of series capacitors 81-84 to match each phase segment 77-80 of the antenna arrangement 30 is 4C The equivalent circuit in FIG. 4B shows the schematic wiring arrangement in accordance with the present invention. The corresponding voltage drops across the phase segments 77-80 of the antenna arrangement 30 and the series capacitors 81-84 is thus very much reduced.

Referring to FIG. 4A and FIG. 4C, a vector diagram shows the voltages across the antenna arrangement 30 with total inductance L. The voltage drops across the phases 75 of the antenna arrangement 30 is V₇₅ and the voltage drop across the impedance tuning capacitor 76 (with capacitance C) is V₇₆ can be very large and are represented by the dashed lines in FIG. 4C.

The voltage drops V₇₇-V₈₀ corresponding to each phase segment 77-80, V₈₁-V₈₄ corresponding to each of the series capacitor 81-84 and the total voltage drop across the antenna arrangement V_{I-II} are represented in FIG. 4C by the solid lines. In the antenna arrangement 30 configuration of FIG. 4B, the voltage drops V₇₇-V₈₀ across any of the phase segments 77-80 is four times smaller than V₇₅. Furthermore, the voltage drop V₈₁-V₈₄ across any of the series capacitors 81-84 is also four times smaller than V₇₆.

Referring to FIG. 3 and FIG. 4B, each of the first 25 plurality of current carrying conductors in the antenna arrangement 30 can thus be coupled to each of the second 26 plurality of current carrying conductors via a capacitor specifically an impedance matching capacitor for reducing voltage drop across the entire antenna arrangement 30. Alternatively, the impedance matching capacitors may be connected between a predetermined number of current carrying conductors in the antenna arrangement 30.

In an alternative embodiment, the first and second unidirectional oscillating RF currents may be driven by different RF generators. The first 25 plurality of current carrying conductors could be coupled to a fist RF generator and the second 26 plurality of current carrying conductors coupled to a second RF generator, where both generators operate in a synchronized phase-locked mode. The fist 25 and second 26 plurality of current carrying conductors would differ from that of the preferred embodiment and would not be coupled in series alternately.

Generating a plasma in the plasma reactor 10 would in accordance with the alternative embodiment then involve a method having the steps of firstly introducing a process gas into the reactor chamber 12 of the plasma reactor 10. Next, introducing a first unidirectional oscillating RF current into the first 25 plurality of current carrying conductors in the first direction and then introducing a second unidirectional oscillating RF current into the second 26 plurality of current carrying conductors. A time varying RF electrical field azimuthally shifted on 45° with respect to the first and second direction of the first 25 and second 26 unidirectional oscillating RF currents is thus generated.

Alternatively, generating a plasma in accordance with the alternative embodiment could further involve a method having the steps of first introducing a process gas into the plasma reactor 10 and then introducing a first unidirectional oscillating RF current sheet in the first direction and then a second unidirectional oscillating RF current sheet in a second direction inside the plasma reactor 10. The time varying RF electrical field generated is then azimuthally shifted on 45° with respect to the first and second direction of the first and second unidirectional oscillating RF current sheets.

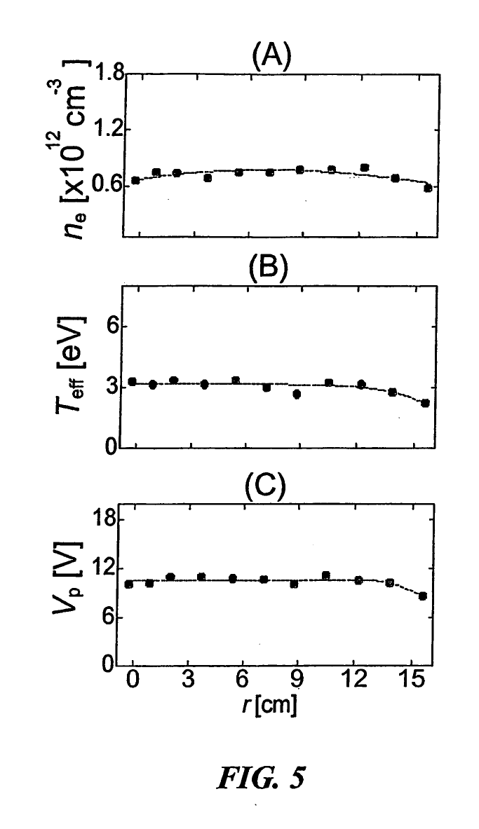

Referring to FIG. 5A, the uniformity of the generated plasma in a radial direction in the plasma reactor 10 is illustrated. The results of experimental data presented in FIG. 5 correspond to a 51 mTorr argon discharge, sustained in an electromagnetic (H) mode with 0.62 kW RF input within a plasma reactor having a radius of about 16 cm Measurements of radial profiles of plasma density nₑ in FIG. 5A were made using an RF-compensated Langmuir probe (LP). The radial scans were performed along the direction of the resulting RF current/field oscillation (arrowed line 35 in FIG. 3). FIG. 5A shows that non-uniformity of the plasma density nₑ is within 7% along the radius of the reactor chamber 12.

FIG. 5B, shows the effective temperature of the plasma electrons T_{eff} to be highly uniform in the radial direction until nearing the walls of the plasma reactor. FIG. 5C, shows the plasma potential Vp of the generated plasma also being highly uniform in the radial direction until nearing the walls of the plasma reactor.

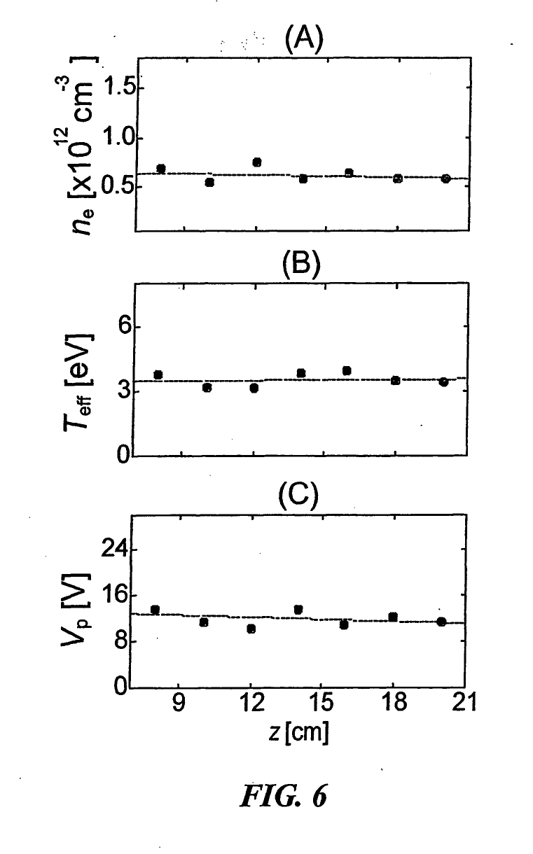

FIG. 6A illustrates excellent axial uniformity for nₑ, FIG. 6B for T_{eff}, and FIG. 6C for Vₚ at the same pressure and RF power as FIG. 5 but in a different discharge in pure argon. The non-uniformity of the plasma density is less than 10% along the vertical axis of the reactor chamber 12. Referring now to both FIG. 5 and FIG. 6, total volume non-uniformity of the plasma generated is within 10%, which is a substantial improvement over many conventional plasma-generating devices.

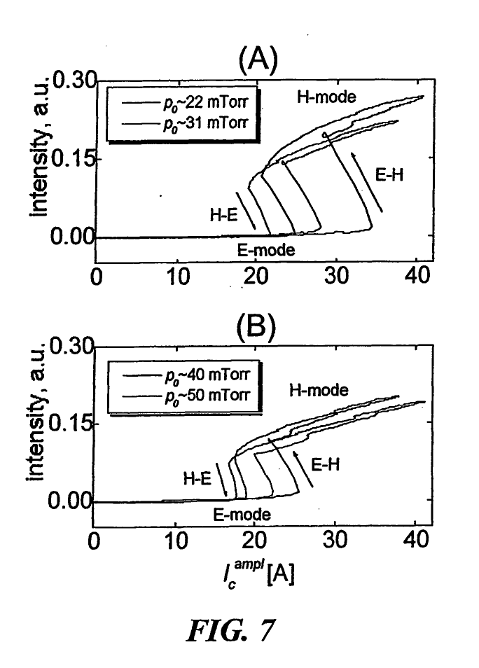

The plasma reactor 10 in accordance with the present invention can operate in either electrostatic (E) or electromagnetic (H) modes. In the H-mode the plasma discharges yield highly luminous and dense plasmas with the plasma density in the range of 10¹¹−9×10¹² cm^{—3} and electron temperatures in the range of 1.5-5 eV with moderate RF powers not exceeding 2.5 kW. In the E-mode, the plasma density is typically one or two orders of magnitude lower, whereas the electron temperatures are higher (7-15 eV). Variation of the input power can result in E-H and H-E transitions (each of them is non-reversible due to hysteretic effects) between the two modes of operation, as shown in FIG. 7, which depicts variation of the optical emission intensity of neutral argon line (840.82 nm) during E-H and H-E mode transitions with variation of the RF coil current at different (22, 31, 40, and 50 mTorr) argon gas pressures. This feature of the plasma source offers great flexibility in selecting optimal discharge operating parameters for the plasma processing applications.

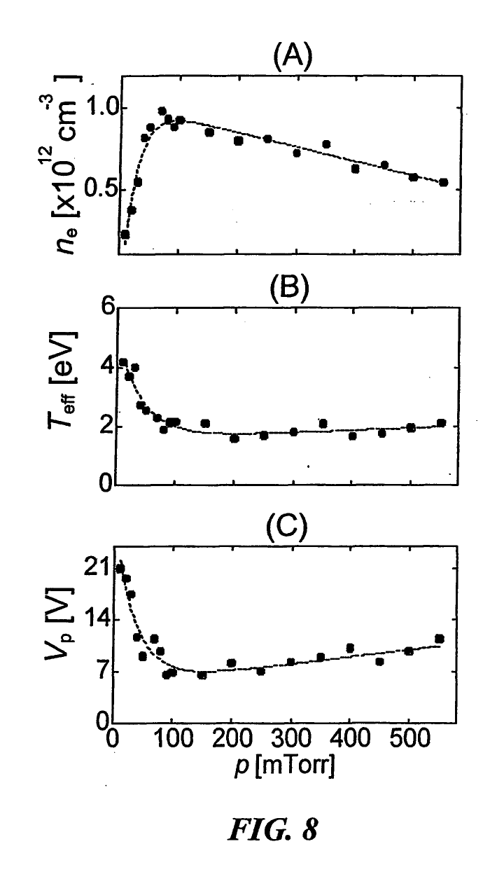

The highly uniform plasma can also be generated in a wide range of operating gas pressures. Referring to FIG. 8, highly uniform and stable plasmas were generated with RF powers of 1.24 kW while varying the pressure range from 5-600 mTorr. The nₑ as in FIG. 8A, the T_{eff}, as in FIG. 8B and the Vₚ as in FIG. 8C exhibit the performance of the plasma reactor over the pressure range. This allows the plasma reactor 10 of the present invention to be highly flexible for a variety of processing applications at different pressures. The operating pressure range of the plasma reactor 10 in accordance with the present invention may further be extended to several Torr range by simple modifications of gas flow controllers and vacuum systems used together with the plasma reactor 10.

In prior art systems developed for uniform plasma generation, a variety of methods using electromagnetic, magnetic fields and various antenna configurations are used. When such prior art systems are required to be up-scaled or a much larger system required, the prior art systems disadvantageously face several problems during implementation. Such up-scaling is not a matter of increasing component capacities and physical dimensions of the required circuitries but a detailed and complicated process of redesigning around an existing system or a complete new design.

The present invention allows a highly uniform plasma to be generated with an antenna arrangement 30 which is advantageously highly scalable without the associated problems of the prior art systems. Up-scaling a system in accordance with the present invention is a matter of increasing dimensions for the reactor as well as the corresponding dimensions and capacities for the current carrying conductors and the relevant capacitors and RF generators. The simple circuitry of the present invention advantageously allows the up-scaling to be performed with much less redesign.

Due to remarkably increasing recent demand for highly uniform, high-density, low- and intermediate pressure plasmas, commercialization of the invention can also offer great potential applications in deep micron semiconductor processing, multi-layer nano-scaled film deposition, including heterostructures and superlattices, surface processing and modification, bio-compatible ceramics, deposition of superhard wear-resistant coatings, and several others.

The expected outcomes of commercialization of the invention are not merely limited to the items specified above. Great flexibility, reproducibility, and stability of the plasma in the newly developed plasma reactor will allow easy adjustment to a large number of another potential materials processing technologies, should the need arise.

It will be appreciated that various modifications and improvements can be made by a person skilled in the art without departing from the scope of the present invention.

1-18. (canceled)

19. A method for generating a uniform plasma, the method comprising:
a. introducing a process gas into a plasma reactor;
b. introducing an RF antenna having a first unidirectional oscillating current in a first direction and a second unidirectional oscillating current in a second direction inside the plasma reactor; and
c. the first unidirectional oscillating RF current sheet is substantially perpendicular to the second unidirectional oscillating current sheet wherein the unidirectional oscillating RF currents are oscillating at a frequency range of 300 to 1000 kHz.

20. The method in accordance with claim 19, further wherein the RF antenna having first and second unidirectional oscillating currents generate a time varying RF electrical field azimuthally shifted on 45° with respect to the first and second direction of the first and second unidirectional oscillating RF currents.

21. The method in accordance with claim 19, wherein the process gas comprises: argon, nitrogen, methane, or hydrogen or a combination of any of the mentioned gases.

22. The method in accordance with claim 19, wherein the first and second unidirectional oscillating RF currents exhibit substantially no phase differences.

23. A method for generating a uniform plasma, the method comprising:
a. introducing a process gas into a plasma reactor:
b. introducing a unidirectional oscillating RF current into a first plurality of current carrying conductors in a first direction and a second plurality of current carrying conductors in a second direction;
c. generating a time varying RF electrical field azimuthally shifted with respect to the first and second direction of the unidirectional oscillating RF currents; and
d. the unidirectional oscillating RF current in the first and second plurality of current carrying conductors exhibit substantially no phase differences;
wherein the unidirectional oscillating RF current is oscillating at a frequency range of 300 to 1000 kHz.

24. The method in accordance with claim 23, wherein the process gas comprises: argon, nitrogen, methane, or hydrogen or a combination of any of the mentioned gases.

25. A method for generating a uniform plasma, the method comprising:
a. introducing a process gas into a plasma reactor:
b. introducing a first unidirectional oscillating RF current into a first plurality of current carrying conductors in a first direction;
c. introducing a second unidirectional oscillating RF current into a second plurality of current carrying conductors in a second direction;
d. generating a time varying RF electrical field azimuthally shifted with respect to the first and second direction of the first and second unidirectional oscillating RF currents; and
e. the first and second unidirectional oscillating RF currents exhibit substantially no phase differences;
wherein the first and second unidirectional oscillating RF currents are oscillating at a frequency range of 300 to 1000 kHz.

26. The method in accordance with claim 25, wherein the process gas comprises: argon, nitrogen, methane, or hydrogen or a combination of any of the mentioned gases.

27. A method for generating a uniform plasma, the method comprising:
a. introducing a process gas into a plasma reactor;
b. introducing a unidirectional oscillating RF current into a first plurality of current carrying conductors in a first direction;
c. introducing the unidirectional oscillating RF current into a second plurality of current carrying conductors in a second direction;
d. generating a time varying RF electrical field azimuthally shifted with respect to the first and second direction of the unidirectional oscillating RF currents; and
e. the unidirectional oscillating RF current in the first and second plurality of current carrying conductors exhibit substantially no phase differences;
wherein the unidirectional oscillating RF current is oscillating at a frequency range of 300 to 1000 kHz.

28. The method in accordance with claim 27, wherein the process gas comprises: argon, nitrogen, methane, or hydrogen or a combination of any of the mentioned gases.

29. An antenna arrangement for an inductively coupled plasma reactor comprising:
a first plurality of substantially parallel current carrying conductors oriented in a first direction;
a second plurality of substantially parallel current carrying conductors oriented in a second direction;
the first and second current carrying conductors for carrying unidirectional oscillating RF currents in a first and second direction respectively;
the first direction being substantially perpendicular to the second direction;
the first plurality of substantially parallel current carrying conductors is disposed planarly above the second plurality of substantially parallel current carrying conductors; and
wherein the unidirectional oscillating RF current is oscillating at a frequency range of 300 to 1000 kHz.

30. The antenna arrangement in accordance with claim 29, wherein the first and second plurality of substantially parallel current carrying conductors adapted to generate a time varying RF electrical field azimuthally shifted on 45° with respect to the first and second direction.

31. The antenna arrangement in accordance with claim 29, wherein the first plurality of substantially parallel current carrying conductors are alternately electrically coupled to the second plurality of substantially parallel current carrying conductors.

32. The antenna arrangement in accordance with claim 31, wherein at least one capacitor is connected between a predetermined number of the first plurality of substantially parallel current carrying conductors and a predetermined number of the second plurality of substantially parallel current carrying for minimizing reactance.

33. A plasma reactor comprising:
a. a plasma reactor chamber adapted for plasma processing and for introducing of a process gas; and
b. an RF antenna arrangement comprising a first plurality of substantially parallel current carrying conductors in a first direction;
c. a second plurality of substantially parallel current carrying conductors in a second direction;
d. the first and second plurality of current carrying conductors for carrying unidirectional oscillating RF currents in a first and second direction respectively; and the first direction being substantially perpendicular to the second direction; and
e. the first plurality of substantially parallel current carrying conductors is disposed planarly above the second plurality of substantially parallel current carrying conductors;
wherein the unidirectional oscillating RF current is oscillating at a frequency range of 300 to 1000 kHz.

34. The inductively coupled plasma reactor in accordance with claim 33, wherein the first and second plurality of substantially parallel current carrying conductors are disposed inside the plasma reactor chamber.

35. The inductively coupled plasma reactor in accordance with claim 33, wherein each of the first and second plurality of substantially parallel current carrying conductors is contained inside each of a plurality of dielectric sleeves.

36. The inductively coupled plasma reactor in accordance with claim 35, wherein the plasma reactor chamber is adapted to accommodate the plurality of dielectric sleeves and still maintain vacuum integrity of the plasma reactor chamber.
